(19) United States
(12) Patent Application Publication
(10) Pub. No.: US 2010/0266378 A1
(43) Pub. Date: Oct. 21, 2010

(54) LOADING DEVICE

(76) Inventor: Paul Verwys, Grand Rapids, MI (US)

Correspondence Address: ROBERT J. SAYFIE, P.C., 161 OTTAWA AVENUE NW, SUITE 407, GRAND RAPIDS, MI, 49503, US

(21) Appl. No.: 12/425,373

(22) Filed: Apr. 16, 2009

(51) Int. Cl. B60P 1/43; B60P 3/07; B65G 69/28

(52) U.S. Cl. 414/537

(57) ABSTRACT

A device that may be mounted on a bed of a pickup truck to enable smaller vehicles, such as motorcycles, snowmobiles, or all-terrain vehicles to enter from the ground level upon a platform of the loading device. This is accomplished by the loading device having a ramp that can be pulled outwardly or rearwardly from said device, and a motorcycle can drive up the ramp to the platform. A dolly slide is pulled outwardly from the device, and extends above the tailgate. The ramp then extends downwardly from the dolly slide, so that no weight or load is displaced on the tailgate.

### GOVERNMENT RIGHTS

This invention was not made with Government support under. The Government does not have any rights in this invention.

### BACKGROUND OF THE INVENTION

Loading devices may be used to load, or unload things from one level, to a different level. For example, a loading device may be used to assist in loading motorcycles onto the beds of pickup trucks.

U.S. Pat. No. 5,795,125 (“the '125 patent”) illustrates one type of loading device, called a truck ramp assembly 10. This discloses a platform assembly having an closed front end (no reference numeral); a pair of longitudinally extending track members (no reference numerals); evenly spaced transverse support members 40; a hollow interior 26; and a pair of wheels 70 on opposite sides thereof at a first end (no reference numeral). The '125 patent requires the use of a tailgate because a pair of wheels 70 rest on the tailgate. Further, wheels 82 also rest on the tailgate. Because the fore mentioned wheels rest on the tailgate of the pickup truck, the tailgate may encounter loads, which may damage the tailgate or the operation of the tailgate. The '125 patent also has apertured brackets 32 to secure the platform assembly 10 to a vehicle 12. The '125 patent does not disclose a way to accommodate for varied pickup truck bed lengths. The '125 patent does not disclose an apparatus by which a short bed pickup, such as 8 ft., can accommodate a load requiring a bed or platform length of a long bed, such as 11 ft.

As can be seen, there is a need for a loading device that does not cause weight to bear on the tailgate; that can accommodate for varied pickup truck bed lengths; and that can allow a short bed truck to receive a load requiring a truck bed or platform length of a long bed pickup truck.

### SUMMARY OF THE INVENTION

One aspect of the present invention is a loading device, comprising a housing (600) slidably disposed to a bed (500); a dolly slide (460) slidably disposed to said housing (600); and a ramp (40) slidably disposed to said dolly slide (460).

Another aspect is a loading device (10), comprising: an A-type platform side (22) secured to opposed sides of a ramp (40); a mounting bracket (60) secured to said A-type platform side (22) and a bed (500) of a vehicle; said A-type platform side (22) having an A-type decking channel (118); and an A-type ramp channel (120) disposed under said A-type decking channel (118).

These and other features, aspects and advantages of the present invention will become better understood with reference to the following drawings, description and claims.

### BRIEF DESCRIPTION OF THE DRAWINGS

FIG. 1 is a side pictorial view of one embodiment of the present invention in the stowed position.

FIG. 2 is a side pictorial view of an embodiment of the present invention in the deployed position.

FIG. 3 is a side pictorial of an embodiment of the present invention, used as a workbench.

FIG. 4 is another pictorial of the present invention.

FIG. 5 is a pictorial of components of one embodiment of the present invention, used to secure the loading device to a bed.

FIG. 5B is a sectional pictorial of one embodiment of the B-type platform side and the sliding block.

FIG. 5C is a non-sectional pictorial of one embodiment of the B-type platform side.

FIG. 5D is a side view of the B-type platform side.

FIG. 6A is a pictorial of a front hinge plate on one side of the loading device.

FIG. 6B is a pictorial of a front hinge plate on the other side of the loading device.

FIG. 7 is a pictorial of the rear view from the stowed position.

FIG. 8 is a sectional pictorial of a side view of the stowed position.

FIG. 9 is a pictorial view of the ramp composed of decking.

FIG. 11 is a pictorial view of the dolly slide, which allows the ramp to be pulled out from under the platform.

FIG. 12 is sectional pictorial of a closer view from FIG. 8. FIG. 13 is another sectional pictorial of a closer view from FIG. 8.

FIG. 14 is a closer view of a portion from FIG. 7.

FIG. 17 is a pictorial of an A-type platform side.

FIG. 18 is a pictorial of the A-type platform side with the mounting bracket.

### DETAILED DESCRIPTION OF THE INVENTION

The following detailed description is of the best currently contemplated modes of carrying out the invention. The description is not to e taken in a limiting sense, but is made merely for illustrating the general principles of the invention, since the scope of the invention is best defined by the appended claims.

### REFERENCE NUMERALS

10 loading device
20 platform
22 platform side
30 member
32 decking
34 decking tongue
35 decking support member
36 decking groove
37 ramp side
40 ramp
50 hinge plate
52 hinge plate tongue
54 hinge plate groove
60 mounting bracket
70 mounting bracket slot
80 mounting bracket base
90 mounting bracket arm
100 mounting bracket finger
102 hook portion
110 platform top
112 first side surface
114 second side surface
116 finger securement catch
118 A-type decking channel
120 A-type ramp channel
121 wheel stopper
122 decking support
123 locking means
124 extension
126 ramp support
130 ramp-platform displacement wheel
140 leg
142 leg extension
150 ramp extender
218 B-type decking channel
220 B-type ramp channel
222 B-type platform side
240 sliding channel
241 sliding channel stop member
250 sliding blocks
255 sliding block extension
258 fixator bolt
260 connector
340 second embodiment ramp
360 second embodiment platform
380 forward hinge plate
381 forward hinge plate leg
400 platform lock or platform locking means
404 locking pin
420 base frame
460 dolly slide
470 ramp wheel
480 carriage
500 bed
510 handle
520 hinge
540 stop member
550 ramp leg housing
560 leg top channel
570 dolly slide side
572 inside
574 inside lower member
580 ramp wheel stopper
600 housing

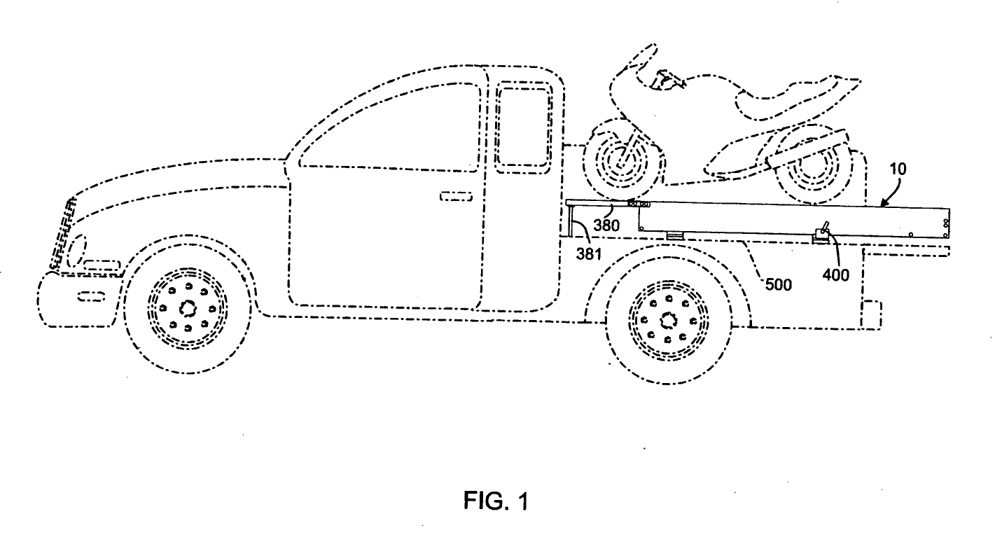

FIG. 1 illustrates an embodiment of a loading device 10 installed on the bed 500 of a pickup truck. A motorcycle is illustrated with the front tire resting on the forward hinge plate 380. The rear tire is resting on the platform 20.

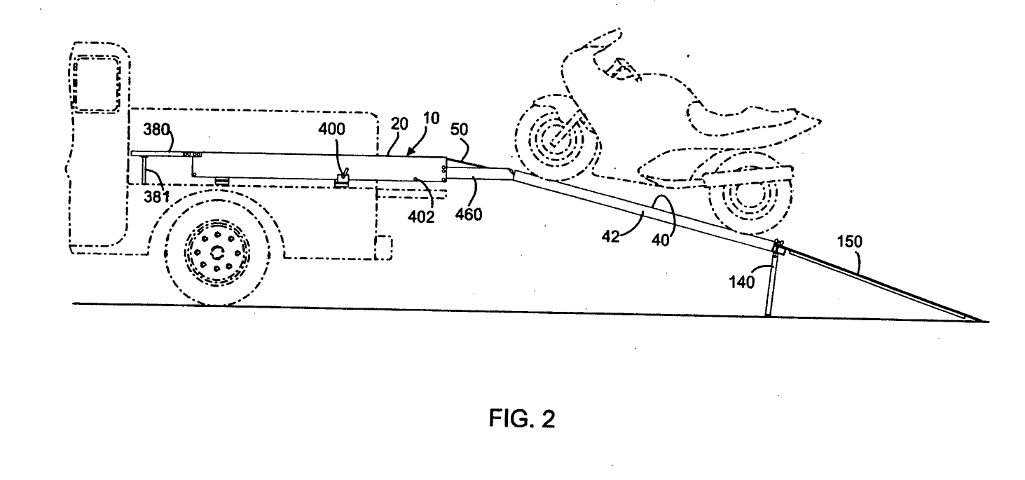

FIG. 2 illustrates a pictorial of a motorcycle on the ramp 40. The ramp 40 is pulled out; and the ramp extender 150 may also be deployed. The ramp 40 may be supported by a leg 140. The forward hinge plate 380 may be folded forward. The dolly slide 460 is pulled out; and the platform 20 is illustrated as pulled out rearwardly with respect to the truck bed 500. The forward hinge plate 380 may be folded rightwardly or rearwardly so that it rests on the platform 20. The platform 20 or loading device 10 may be locked in place by the locking means 400 in a stowed position, for example, when in transit. In one embodiment the locking means 400 may be a locking pin 404 that may engage with a locking hole 402 so that the loading device 10 or platform does not move. This may be preferred when the vehicle on which the loading device 10 is displaced is in transit.

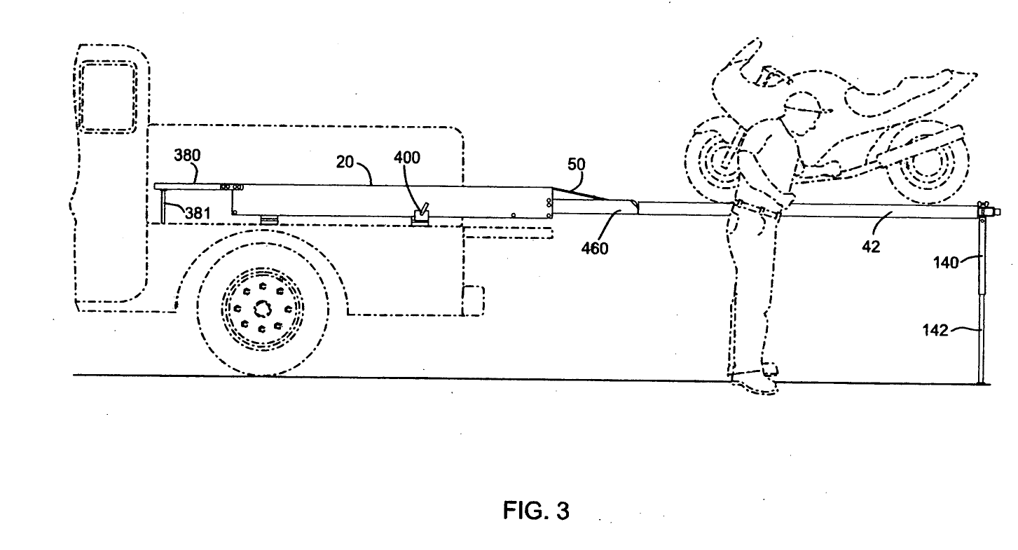

FIG. 3 illustrates a pictorial of the loading device 10 used as a workbench by the ramp 40 being oriented in a substantially horizontal position by a leg 140, and a let extension 142 that may telescope and lock in place by any conventional means.

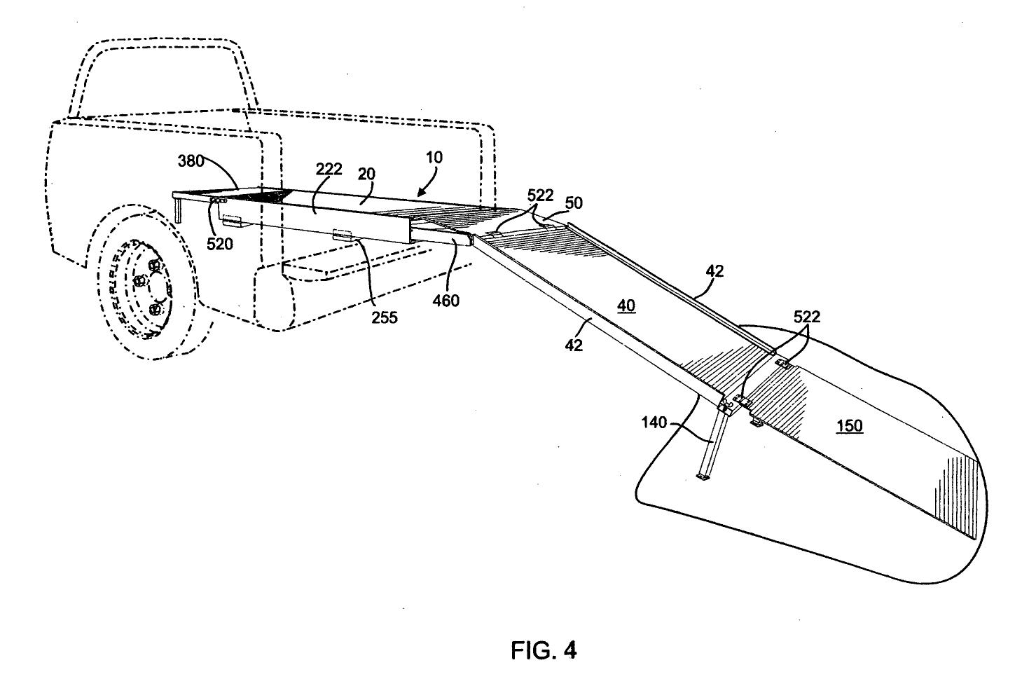

FIG. 4 illustrates another pictorial view of one embodiment of the present invention 10. The loading device 10 is illustrated with the front hinge plate 380 or forward hinge plate 380 extended leftwardly or forwardly via a hinge 520. The dolly slide 460 is shown as disposed rearwardly. The rear hinge plate 50 is shown as flipped forwardly via a hinge 520. The rear hinge plate 50 may be flipped rearwardly also. The rear hinge plate 50 may also be removed. Removal of the rear hinge plate 50 may be useful when a motorcycle or other vehicle is on the platform 20, and an exhaust pipe extends in such a way to prevent the rear hinge plate 50 from flipping rearwardly on to the ramp 40. The ramp extender 150 is shown as deployed or flipped rearwardly from the ramp 40. The ramp extender 150 and the rear hinge plate 50 may both be flipped or folded to rest on the ramp 40 via a hinge 520. This way the ramp 40 may be pushed or displaced under the platform 20. This position may be referred to as the stowed position. The legs 140 may be removable so that the ramp 40 may be displaced in the stowed position.

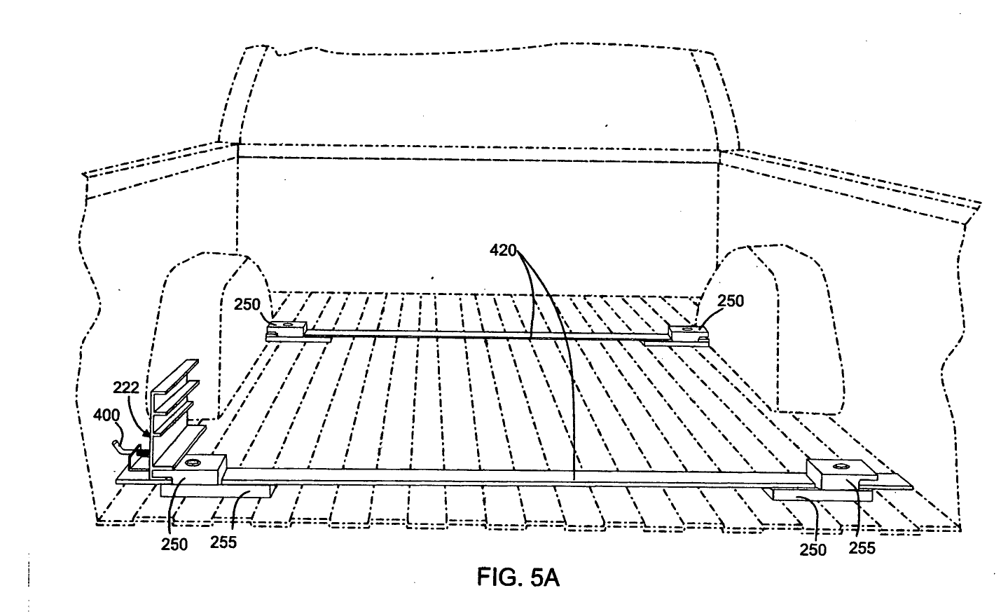

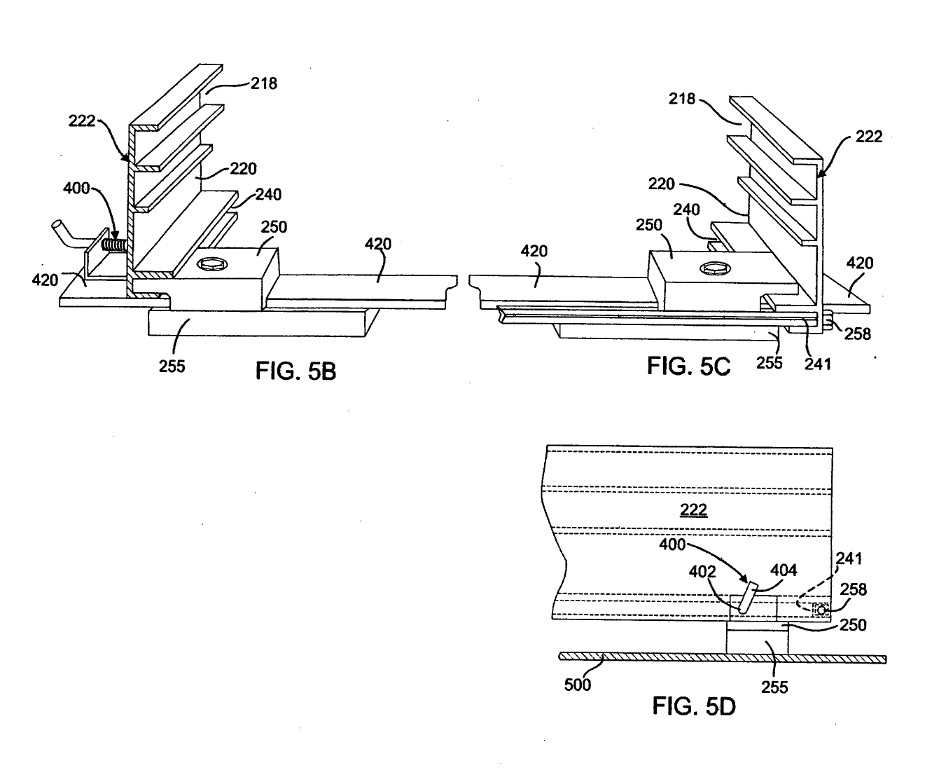

FIG. 5A illustrates one embodiment of securing the loading device 10 to a pickup truck bed 500. A base frame 420 may be disposed on a pickup truck bed 500 in a location to not disrupt wiring a gas tank beneath. A sliding block extension 255 may be secured immediately above a pickup truck bed 500. A sliding block 250 may be disposed immediately above and secured to the sliding block extension 255. A connector 260 may be disposed between said sliding block extension 255 and said sliding block 250. The connector 260 may be the same as a sliding channel stop member 241 as illustrated in FIG. 241. Two base frames 420 may be disposed on the bed 500 of a truck.

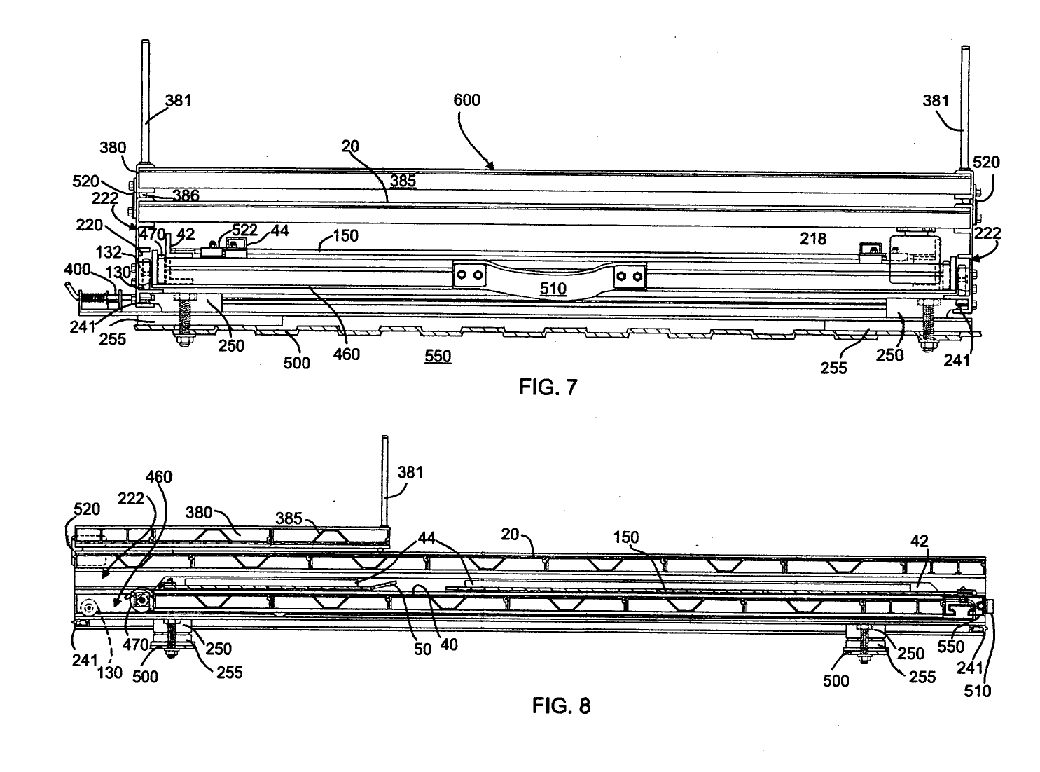

FIG. 5B illustrates on embodiment of the base frame 420 as illustrated in FIG. 5A. FIG. 5B illustrates an embodiment whereby a portion of the sliding block 250 may be disposed in a sliding channel 240. This allows the entire B-type platform side 222 to move forwardly and rearwardly with respect to a pickup truck bed 500 to which it may be slidably disposed. The platform 20 may be secured to the B-type platform side 222 via the B-type decking channel. This relationship is illustrated in FIG. 7.

FIG. 5C illustrates a pictorial whereby the B-type platform side 222 may be secured to a sliding channel stop member 241 via fastener, such as a bolt 258.

FIG. 5D illustrates an embodiment of the B-type platform side 222, as illustrated in FIG. 5B, having a locking means 400. The locking means 400 may be a locking pin 404 that may be removably disposed within a lock hole 402. When the locking pin 404 is removed from engagement with the lock hole 402, then the loading device 10 may slide forwardly and rearwardly via the sliding blocks 250, which may be secured to the bed 500 of a truck via a sliding block extension 255. This way the loading device 10 may be stowed entirely within the bed 500 of a truck when the front hinge plate 380 is folded rearwardly; or it may be pulled out from the bed, as illustrated in FIGS. 1-4. A bolt 258 may secure the B-type platform side 222 to a sliding channel stop member 241.

The platform 40 may be secured to a B-type platform side 222 on opposed sides, as seen in FIG. 7, to define a housing 600. The ramp dolly slide 460 may then be slidably disposed within the housing 600. The ramp 40 may also be slidably disposed within the housing 600.

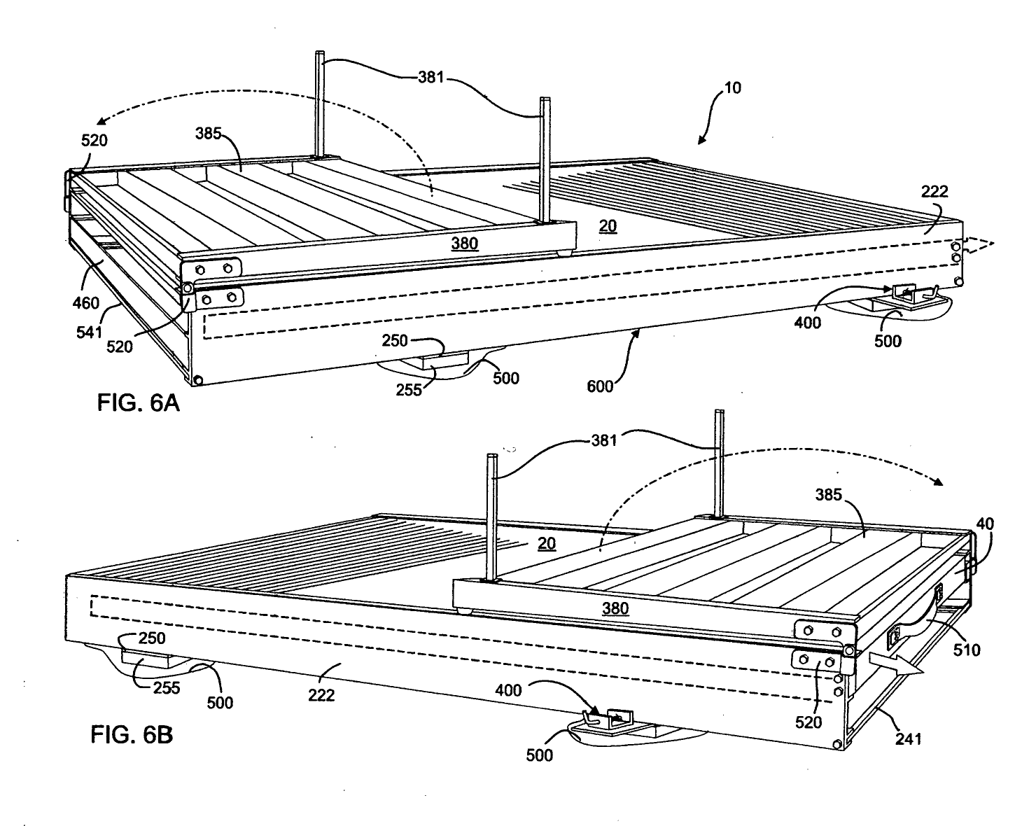

FIG. 6A illustrates an embodiment when a front hinge plate 380 is hingedly disposed on one side of the B-type platform side 222. This is illustrated in FIGS. 1-4. FIG. 6B illustrates another embodiment whereby a front hinge plate 380 may be disposed on the other side of the B-type platform side 222. In the embodiment as illustrated in FIG. 6B, the front hinge plate 380 may flip rearwardly.

FIG. 7 illustrates an embodiment of a rear pictorial showing the front hinge plate 380 hingedly disposed to the B-type platform side. Front hinge plate legs 381 may extend from the front hinge plate 380. The platform 20 may be securely disposed within the B-type decking channel 218. The platform 40 may be slidably disposed within a B-type ramp channel 220. The sliding block 250 may be slidably disposed within the sliding channel 240. The platform 20 may be securely disposed within the B-type decking channel 218. A handle 510 may be disposed on the end of the ramp 40. The sliding block 250 may be secured to a sliding block extension 255 and a bed 500 via a fastener, such as a bolt 258.

Although a sliding block 250 is disclosed as one means by which the loading device 10 may slide back and forth, other means may be used. Such as ball bearings or wheels.

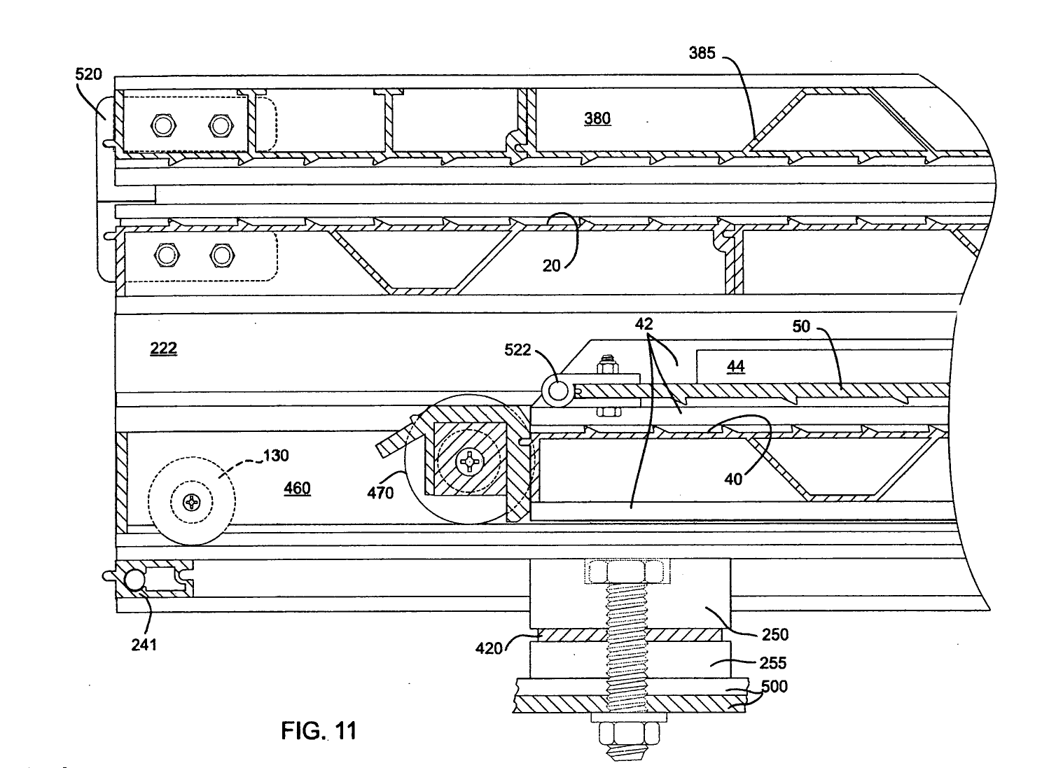

FIG. 8 illustrates a sectional side view pictorial of an embodiment of the present invention 10. The front hinge plate 380 may be hingedly connected to the B-type platform side 222. The rear hinge plate 50 may be hingedly disposed to one side of the ramp 40. The ramp extension 150 may be hingedly disposed to the other side of the ramp 40. The ramp 40 may have a ramp wheel 470 slidably engaged with the dolly slide 460 as illustrated in FIG. 11. The dolly slide 460 may have a ramp-platform displacement wheel 130 that may rotatably engage and roll within the B-type ramp channel 220. This allows the loading device 10 to be pulled or displaced rearwardly by the sliding block 250 sliding relationship with the sliding channel 240 until a stop member 540 contacts a sliding block 250. This allows the loading device 10 to be pulled rearwardly with respect of a truck bed 500. Then the handle 510 can be pulled out or rearwardly to pull the ramp 40 dolly carriage 460 out from under the platform 40. Typically, the dolly carriage 460 extends out above a tailgate so that no load or weight is applied to the tailgate. Then the handle 510 can be further pulled to deploy the ramp 40, as shown in FIG. 2. The dolly carriage 460 may be limited from pulling entirely out by any conventional means that may stop the ramp-platform displacement when 130.

If the stop member 540 was not there, then the entire loading device 10 may be pulled from the bed 500 and fall upon the ground. However, other means for preventing the loading device from falling out may be utilized.

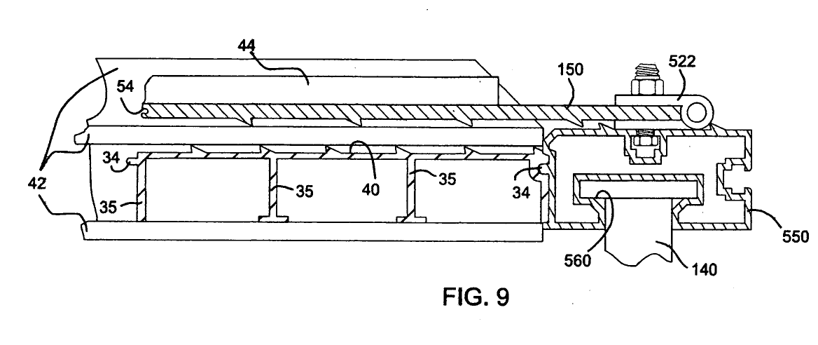

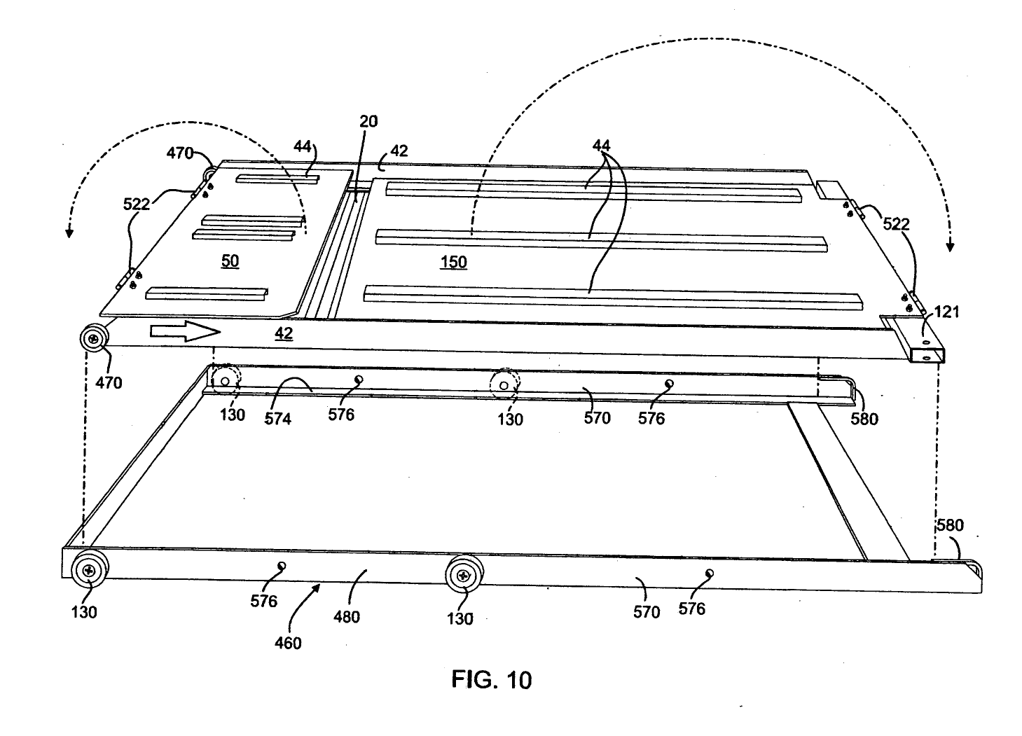

FIG. 9 illustrates one embodiment of a ramp 40, constructed of decking 32. The decking 32 may be of a variety of lengths. The decking 32 may have a tongue 34 on one side that may engage with a groove 34 on a separate decking 32. This way the ramp 40 size may be constructed or altered by adding, removing, or replacing to existing decking 32. The decking 32 may have a decking support member 35 extending downwardly to support the decking 32 within a B-type decking channel 218. In one embodiment a ramp-leg housing 550 may be securely disposed to the ramp 40. The ramp-leg housing 550 may have a leg top channel 560 that is capable of receiving a leg 140 that may be removably disposed within the ramp-leg housing 550.

FIG. 11 is a pictorial of an embodiment of a dolly slide 460 of the present invention 10. The dolly slide 460 may be rollably engaged within the B-type ramp channel 220. The ramp-platform displacement wheel 130 may be rotatably disposed to a dolly slide side 570. The ramp-platform displacement wheel 130 may roll within the B-type decking channel 218. The ramp wheel 470 may be rollably disposed within the inside 572 of the dolly slide side 570. For example, the ramp wheel 470 may roll along an inside lower member 574. A ramp wheel stopper 580 may prevent the ramp wheel 470 from falling out of the inside 572.

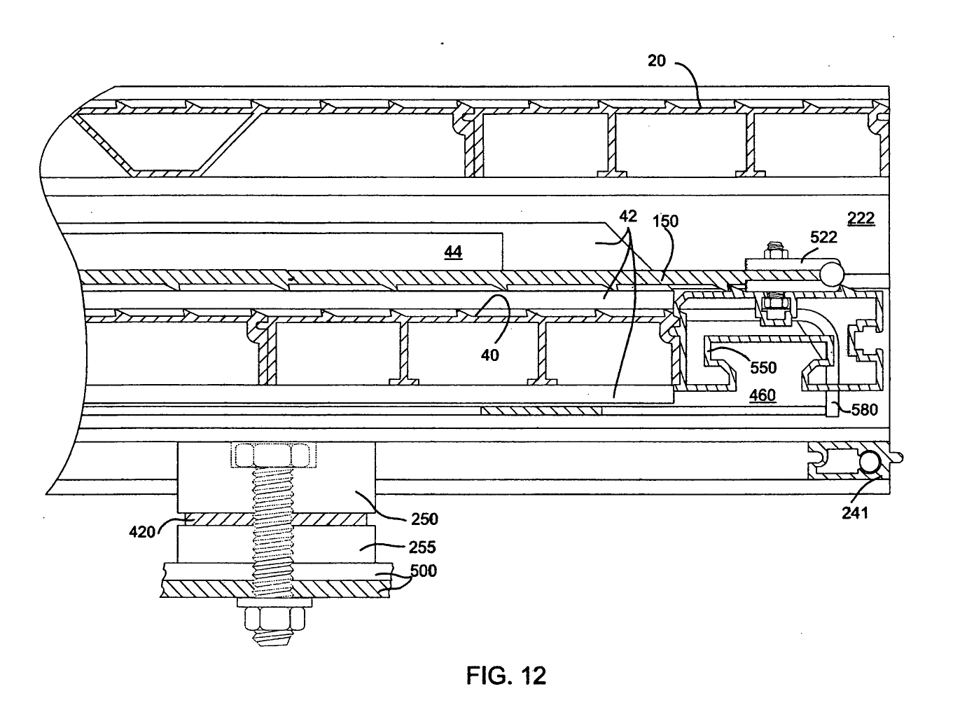

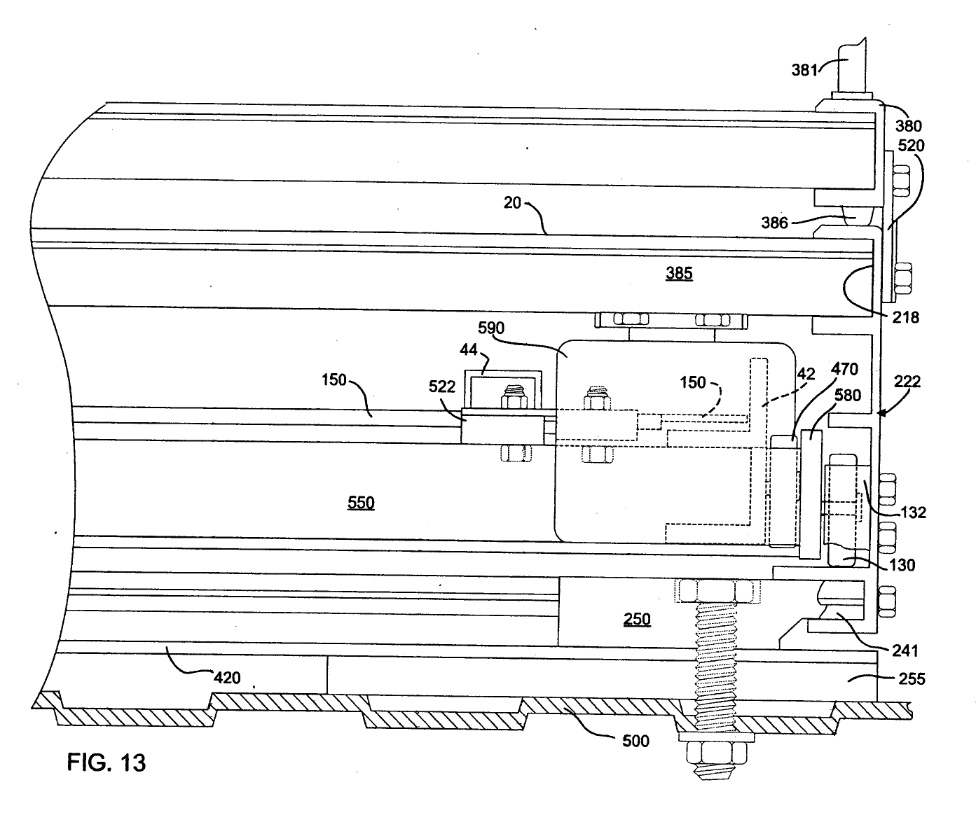

FIG. 12 is a pictorial of a closer view of a portion of FIG. 8. The sliding block 250 may be secured to the bed 500 via a bolt 258. The stop member 540 may be secured within the sliding channel 240 to limit the displacement of the loading device 10, by contacting the sliding block 250 after a certain distance.

FIG. 13 is a pictorial of a closer view of the ramp 40 and the ramp leg housing 550.

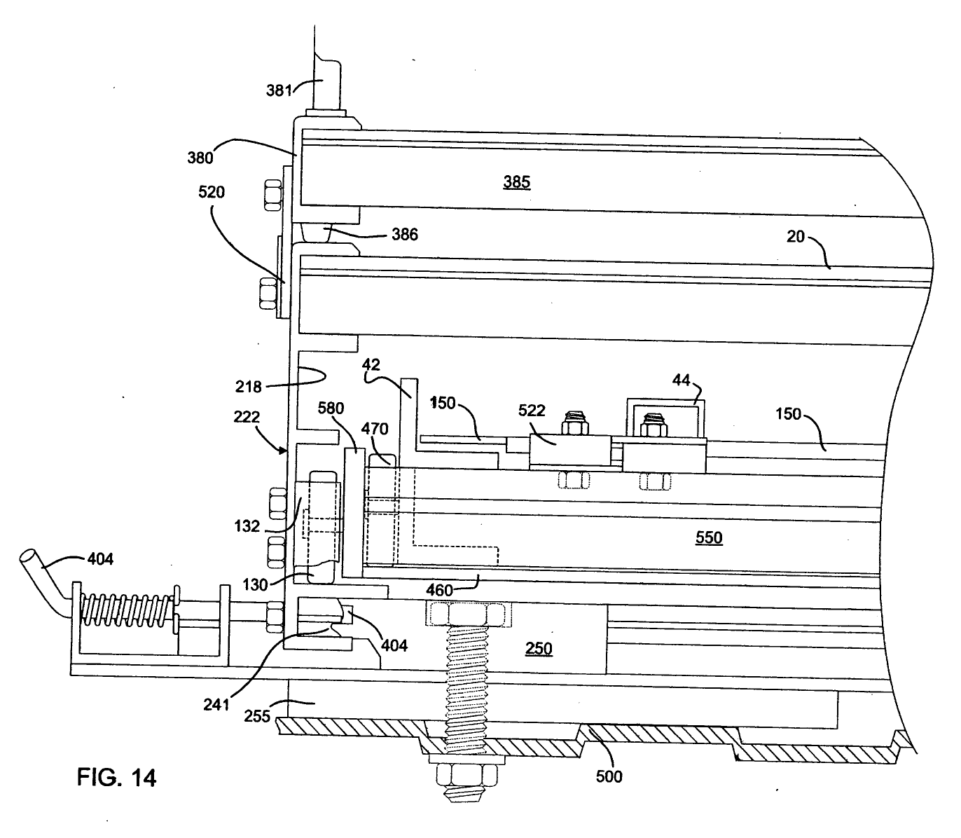

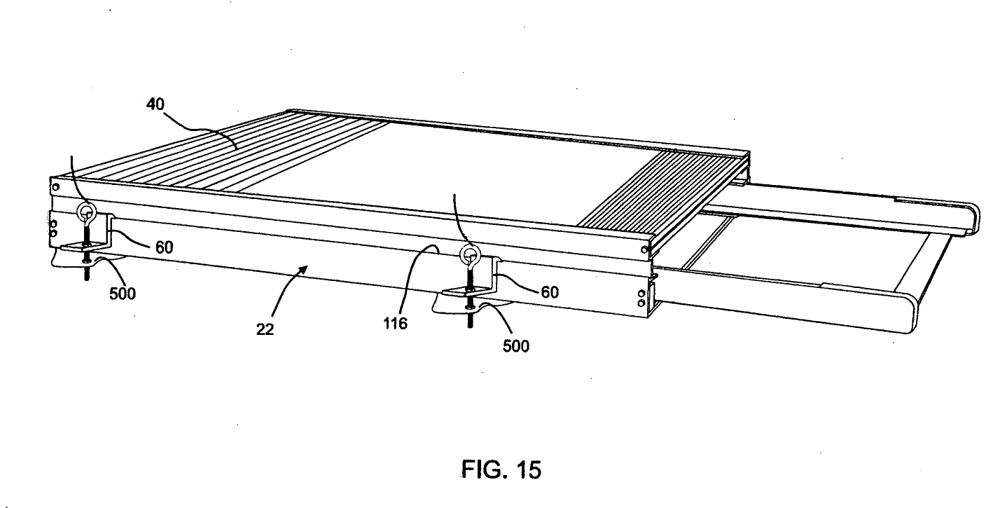

FIG. 14 is a pictorial of a closer view of the bed 500, the B-type platform side 222, the sliding channel 240, the B-type ramp channel 220, the B-type decking channel 218, and other components.

FIG. 17 illustrates an embodiment of an A-type platform side 22. The A-type platform side 22 is disposed on the left side of a bed, and the other on the right side. Only the left side is illustrated in FIG. 17. The A-type platform side 22 may have a decking channel 118 to receive decking 32. The decking may rest on the decking support 122. A ramp channel 120 may be disposed downwardly from said decking channel 118. The ramp channel 120 may be defined by an inside of a second side surface 114, an extension 124 extending inwardly from said second side surface 114, and a ramp support 126 disposed downwardly from said extension 124.

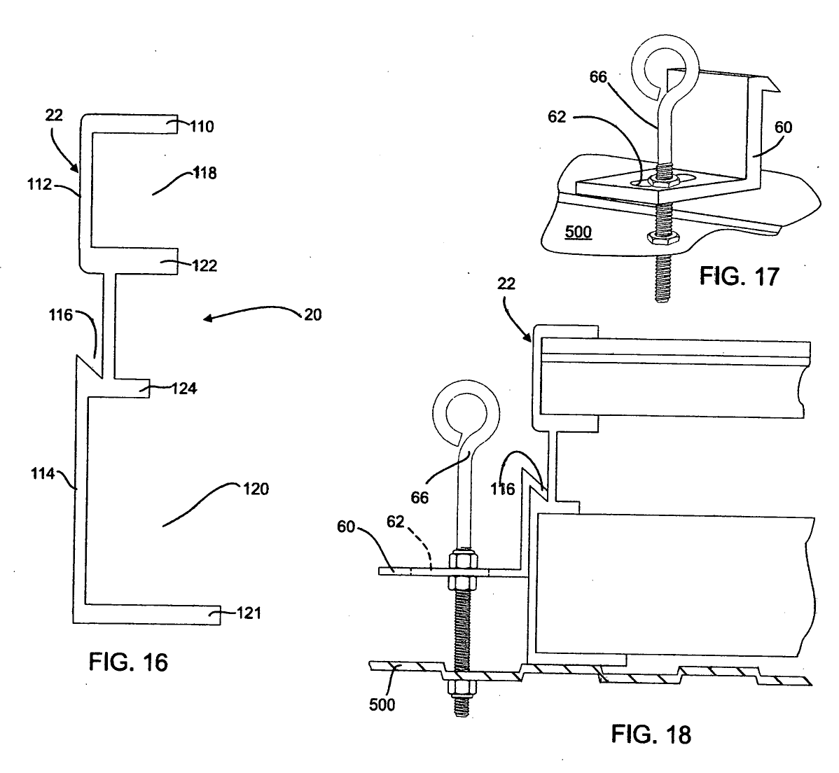

The A-type platform side 22 may have a finger securement catch 116, which mates with the hook portion 102 of the mounting bracket 60 to secure the platform side 22 to the bed, as seen in FIGS. 18 and 19. This is another means of securing the loading device 10 to a bed 500. The A-type platform side 22 may be used with the mounting bracket 60.

FIG. 18 illustrates how the mounting bracket 60 may be secured to the A-type platform side 22 on the top of the bed of the pickup truck.

In the A-type platform side 22 the platform 20 may be secured in the A-type decking channel 118. In the A-type platform side 22, the dolly slide 460 may be slidably disposed within the A-type ramp channel 120 in the same way that it is disposed in the B-type ramp channel 220.

It should be understood, of course, that the foregoing relates to exemplary embodiments of the invention and that modifications may be made without departing from the spirit and scope of the invention as set forth in the following claims.

I claim:

1. A loading device, comprising:
a housing (600) slidably disposed to a bed (500);
a dolly slide (460) slidably disposed to said housing (600); and
a ramp (40) slidably disposed to said dolly slide (460).

2. The loading device of claim 1, wherein said ramp (40) is slidably disposed to said dolly slide (460).

3. The loading device of claim 1, wherein said housing (600) is defined by a platform (20) having a B-type platform side (222) on opposed sides.

4. The loading device of claim 1, further comprising:
a front hinge plate (380) pivotally disposed to said housing (600) whereby said front hinge plate (380) can fold forwardly.

5. The loading device of claim 1, further comprising:
a front hinge plate (380) pivotally disposed to said housing (600) whereby said front hinge plate (380) can fold rearwardly.

6. The loading device of claim 1, further comprising:
a rear hinge plate (50) removably and pivotally disposed on said ramp (40).

7. The loading device of claim 1, further comprising:
a ramp extender (150) is pivotally secured to the ramp (40);
a leg (140) that extends downwardly from said ramp (40).

8. The loading device of claim 1, further comprising:
a leg (140) that extends downardly from said ramp (40).

9. The loading device of claim 1, further comprising:
a base frame (420) secured to a bed (500); said base frame having a sliding block (250) secured to a connector (260) and a sliding block extension (255);
a B-type platform side (222) slidably disposed on said sliding block (250);
a stop member (540) secured in said side channel (240) to limit the displacement of the B-type platform side (222) when pulled rearwardly;
said sliding block (250) slidably disposed within said sliding channel (240).

10. The loading device of claim 1, wherein said housing (600) has a B-type platform side (222) secured to opposed sides of said ramp (40);
said B-type platform side (222) having a B-type decking channel (218); a B-type ramp channel (220) disposed beneath said B-type decking channel (218); and a sliding channel (240 disposed beneath said B-type ramp channel (220);
said platform (40) disposed in said B-type decking channel (218);
said dolly slide (460) rollably disposed in said B-type ramp channel (220); said sliding block (250) slidably disposed in said sliding channel (240); and
a handle (510) disposed on said ramp (40) so that the ramp (40) can be pulled out by the handle (510).

11. A loading device (10), comprising:
an A-type platform side (22) secured to opposed sides of a ramp (40);
a mounting bracket (60) secured to said A-type platform side (22) and a bed (500) of a vehicle;
said A-type platform side (22) having an A-type decking channel (118); and an A-type ramp channel (120) disposed under said A-type decking channel (118).

12. The loading device of claim 11, wherein said ramp (40) is slidably disposed to said dolly slide (460).

13. The loading device of claim 11, wherein said housing (600) is defined by a platform (20) having a B-type platform side (222) on opposed sides.

14. The loading device of claim 11, further comprising:
a front hinge plate (380) pivotally disposed to said housing (600) whereby said front hinge plate (380) can fold forwardly.

15. The loading device of claim 11, further comprising:
a front hinge plate (380) pivotally disposed to said housing (600) whereby said front hinge plate (380) can fold rearwardly.

16. The loading device of claim 11, further comprising:
a rear hinge plate (50) removably and pivotally disposed on said ramp (40).

17. The loading device of claim 11, further comprising:
a ramp extender (150) is pivotally secured to the ramp (40);
a leg (140) that extends downwardly from said ramp (40).

18. The loading device of claim 11, further comprising:
a leg (140) that extends downardly from said ramp (40).

19. The loading device of claim 11, further comprising:
a base frame (420) secured to a bed (500); said base frame having a sliding block (250) secured to a connector (260) and a sliding block extension (255);
a B-type platform side (222) slidably disposed on said sliding block (250);
a stop member (540) secured in said side channel (240) to limit the displacement of the B-type platform side (222) when pulled rearwardly;
said sliding block (250) slidably disposed within said sliding channel (240).

20. The loading device of claim 11, wherein said housing (600) has a B-type platform side (222) secured to opposed sides of said ramp (40);
said B-type platform side (222) having a B-type decking channel (218); a B-type ramp channel (220) disposed beneath said B-type decking channel (218); and a sliding channel (240 disposed beneath said B-type ramp channel (220);
said platform (40) disposed in said B-type decking channel (218);
said dolly slide (460) rollable disposed in said B-type ramp channel (220); said sliding block (250) slidably disposed in said sliding channel (240); and
a handle (510) disposed on said ramp (40) so that the ramp (40) can be pulled out by the handle (510).
